(19) United States
(12) Patent Application Publication
(10) Pub. No.: US 2016/0067896 A1
(43) Pub. Date: Mar. 10, 2016

(54) ROTARY VALVE DEVICE

(71) Applicant: KABUSHIKI KAISHA TOYOTA JIDOSHOKKI, Kariya-shi (JP)

(72) Inventors: Kazuyuki YAMAGUCHI, Kariya-shi (JP); Naoki HIROSE, Kariya-shi (JP)

(73) Assignee: KABUSHIKI KAISHA TOYOTA JIDOSHOKKI, Kariya-shi (JP)

(21) Appl. No.: 14/839,061

(22) Filed: Aug. 28, 2015

(30) Foreign Application Priority Data
Sep. 10, 2014 (JP) 2014-184291

(51) Int. Cl. B29C 45/23; F16K 31/04; F16K 11/074

(52) U.S. Cl. CPC B29C 45/23; F16K 11/074; F16K 31/041

(57) ABSTRACT

A rotary valve device includes a valve body having a valve hole and a plurality of ports connected to the valve hole. The rotary valve device further includes a rotary valve having communication passages and a motor driving to rotate the rotary valve to regulate flow of a fluid. The valve body has a first and a second supply passage that interconnect the valve hole and the ports. The second supply passage is connected to the valve hole at a position that is closer to an axial end of the valve hole than the first supply passage. The fluid supplied from the second supply passage has lower pressure than the fluid supplied from the first supply passage. Sealing members are interposed between an inner peripheral surface of the valve hole and an outer peripheral surface of the rotary valve at respective opposite ends of the valve hole.

### BACKGROUND OF THE INVENTION

The present invention relates to a rotary valve device that is operable to change a flow passage providing fluid communication among a plurality of ports by rotating a rotary valve of the rotary valve device.

Japanese Patent Application Publication No. 2013-113393 discloses an example of rotary valve devices. Referring to FIG. 8, numeral 80 designates the rotary valve device disclosed in the above-cited Publication. The rotary valve 80 device includes a valve body 81 and a rotary valve 90 that is disposed in a valve hole (rotation space) 82 formed through the valve body 81. The valve body 81 has therein a plurality of ports 81A that are opened to the valve hole 82. In the rotary valve device 80, any two ports 81A are not in communication with each other but are connected to the same source of the pressure.

The rotary valve 90 is rotatably disposed in the valve hole 82 of the valve body 81. The rotary valve 90 includes a shaft portion 91 having therein a plurality of holes 91A that are mutually connected. The rotary valve 90 is rotatable relative to the valve body to at least three angular positions. With the rotation of the rotary valve 90, the ports 81A of the valve body 81 are controllably connected to or disconnected from the inner holes 91A of the rotary valve 90 so as to cause hydraulic oil to flow in any desired direction thereby to control the operation of an actuator. In the rotary valve device 80 of the above-cited Publication, the rotary valve 90 is driven by a stepping motor or a servo-motor.

Although the rotary valve device 80 of the above cited Publication has a single supply source of hydraulic oil connected to the port 81A, a rotary valve device may have two supply sources of the hydraulic oil such as high-pressure hydraulic oil and a low pressure hydraulic. In such case, it requires to prevent the high-pressure hydraulic oil from mixing into the low-pressure hydraulic oil and leaking out from the valve hole by sealing between the outer periphery of the rotary valve and the inner periphery of the valve hole. Consequently, the rotary valve device provided with two supply sources needs a sealing member for high-pressure, which causes a large resistance at the rotation of the rotary valve, thus preventing high-speed rotation.

The present invention, which has been made in the light of the above-mentioned problems, is directed to providing a rotary valve device that permits high-speed rotation.

### SUMMARY OF THE INVENTION

In accordance with an aspect of the present invention, there is provided a rotary valve device including a valve body having a valve hole and a plurality of ports connected to the valve hole. The rotary valve device further includes a rotary valve that is rotatably supported in the valve hole and has a plurality of communication passages and a motor that drives to rotate the rotary valve to regulate flow of a fluid. The valve body has a first supply passage that interconnects the valve hole and at least one of the ports, and a second supply passage that interconnects the valve hole and at least another of the ports. The second supply passage is connected to the valve hole at a position that is closer to an end of the valve hole in an axial direction of the valve hole than the first supply passage. The fluid supplied from the second supply passage to the valve hole when the second supply passage communicates with the valve hole has lower pressure than the fluid supplied from the first supply passage to the valve hole when the first supply passage communicates with the valve hole. A pair of sealing members are interposed between an inner peripheral surface of the valve hole and an outer peripheral surface of the rotary valve at respective opposite ends of the valve hole in the axial direction of the valve hole.

Other aspects and advantages of the invention will become apparent from the following description, taken in conjunction with the accompanying drawings, illustrating by way of example the principles of the invention.

### BRIEF DESCRIPTION OF THE DRAWINGS

The invention together with objects and advantages thereof, may best be understood by reference to the following description of the presently preferred embodiments together with the accompanying drawings in which:

FIG. 1 is a schematic diagram showing an injection molding device and a rotary valve device according to an embodiment of the present invention;

FIGS. 2A and 2B are perspective views of the rotary type valve device of FIG. 1;

FIG. 3 is a longitudinal cross-sectional view of the rotary valve compressor of FIG. 1;

FIG. 4 is a schematic diagram of the injection molding device and the rotary valve device of FIG. 1 during a high-speed phase operation;

FIGS. 5A, 5B, 5C and 5D are cross-sectional views of the rotary valve device of FIG. 3 during high-speed operation, taken along line I-I, line II-II, line III-III and line IV-IV, respectively;

FIGS. 6A, 6B, 6C and 6D are cross-sectional views of the rotary valve device of FIG. 3 during high-pressure operation, taken along line I-I, line II-II, line III-III and line IV-IV, respectively;

FIG. 7 is a schematic diagram showing the injection molding device and the rotary valve device during a pressure boost phase operation; and

FIG. 8 is a perspective view showing a conventional rotary valve device according to the background art.

### DETAILED DESCRIPTION OF THE EMBODIMENTS

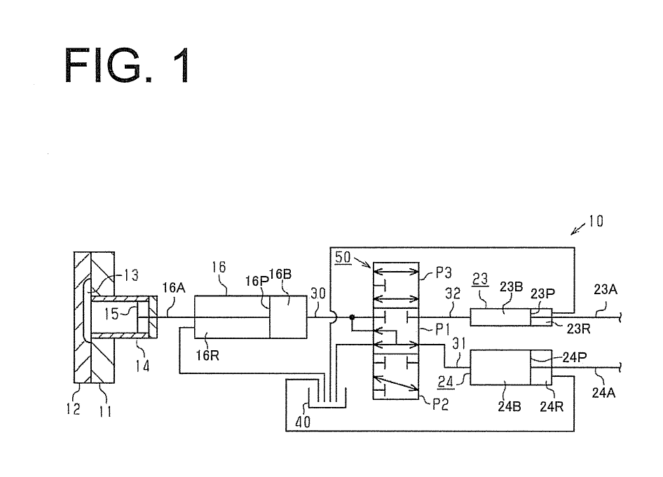

The following will describe a rotary valve device that is adapted for use in an injection molding device according to an embodiment of the present invention with reference to FIGS. 1 to 7. Firstly, the injection molding device will be described.

Referring to FIG. 1, the injection molding device, which is designated by numeral 10, injects a molten metal as the molding material such as aluminum into a cavity 13 formed by a fixed mold member 11 and a movable mold member 12. A molded article is formed when the molding material is solidified and then removed. There is provided a mold clamping device (not shown) that opens, closes and clamps the fixed mold member 11 and the movable mold member 12.

The injection molding device 10 includes an injection cylinder 16 having a piston rod 16A and an injection plunger 15 connected to the end of the piston rod 16A. The injection cylinder 16 drives the injection plunger 15. The injection molding device 10 further includes an injection sleeve 14 that is in communication with the cavity 13. The injection plunger 15 driven by the injection cylinder 16 forces the molten metal molding material provided in the injection sleeve 14 into the cavity 13. In other words, injection plunger 15 injects and fills a molding material into the cavity 13.

The injection cylinder 16 is connected to a high-speed cylinder 24 and a pressure boost cylinder 23 which supply and discharge hydraulic oil as the fluid. Specifically, the injection molding device 10 has a main-tube 30 that serves as a supply and discharge passage of the hydraulic oil, and one end of the main-tube 30 is connected to a bottom chamber 16B of the injection cylinder 16 and the other end of the main-tube 30 is connected to a rotary valve device 50, functioning as a switch valve. The rotary valve device 50 corresponds to the switch valve of the present invention. In addition, the injection molding device 10 further has a first sub-tube 31 and a second sub-tube 32 that are connected at one ends thereof to the rotary valve device 50 and serve as supply and discharge passage of the hydraulic oil. The rotary valve device 50 is connected to a hydraulic oil reservoir 40 via the tubes.

The other end of the first sub-tube 31 is connected to a bottom chamber 24B of the high-speed cylinder 24 that supplies fluid hydraulic oil to the bottom chamber 16B of the injection cylinder 16. The other end of the second sub-tube 32 is connected to a bottom chamber 23B of the pressure boost cylinder 23 that also supplies hydraulic oil to the bottom chamber 16B of the injection cylinder 16. A rod chamber 24R of the high-speed cylinder 24 and a rod chamber 23R of the pressure boost cylinder 23 are both connected to the reservoir 40.

The pressure boost cylinder 23 has a diameter that is smaller than that of the high-speed cylinder 24. The high-speed cylinder 24 has a piston 24P and a piston rod 24A having at the end thereof the piston 24P and connected to a power source (not shown). Similarly, the pressure boost cylinder 23 has a piston rod 23A having at the end thereof the piston 23P and connected to another power source (not shown either).

The injection molding device 10 having above described configuration is operable in two different phases, namely high-speed phase and pressure boost phase. The initial operation of the injection molding is performed in the high-speed phase during which the piston 16P of the injection cylinder 16 is moved at high-speed to force the molten metal in the injection sleeve 14 into the cavity 13 of the mold members 11, 12. During the high-speed phase operation, the injection pressure being applied to the molten metal material is increased gradually to a predetermined pressure. Thus, the high-speed phase operation takes place during the operation of the high-speed cylinder 24.

The pressure boost phase operation, which takes place after the high-speed phase operation, is the last step of the injection molding process during which the molten metal in the cavity 13 is pressurized by further forward movement of the piston 16P of the injection cylinder 16, or the injection plunger 15. During the pressure boost phase operation, the injection pressure applied to the molten metal material in the injection sleeve 14 is greater than the injection pressure during the high-speed phase operation. Thus, the pressure boost phase operation takes place during the operation of the pressure boost cylinder 23.

The following will describe the rotary valve device 50. The rotary valve device 50 is operative in three different positions, namely the first position P1, the second position P2 and the third position P3 that are shown in FIG. 1. In the first position P1 shown in FIG. 1, the rotary valve device 50 provides communication between the bottom chamber 24B of the high-speed cylinder 24 and the reservoir 40 and between the bottom chamber 24B of the high-speed cylinder 24 and the bottom chamber 16B of the injection cylinder 16, while shutting off the communication between the bottom chamber 23B of the pressure boost cylinder 23 and the bottom chamber 16B of the injection cylinder 16.

Referring to FIG. 4, the rotary valve device 50 in the second position P2 provides communication between the bottom chamber 24B of the high-speed cylinder 24 and the bottom chamber 16B of the injection cylinder 16, while shutting off the communication between the bottom chamber 23B of the pressure boost cylinder 23 and the bottom chamber 16B of the injection cylinder 16. In the second position P2, the bottom chamber 24B of the high-speed cylinder 24 and the bottom chamber 23B of the pressure boost cylinder 23 are not in communication with the reservoir 40. In this second position P2 of the rotary valve device 50, the high-speed phase operation is performed.

In the second position P2 of the rotary valve device 50, hydraulic oil in the bottom chamber 24B of the high-speed cylinder 24 is supplied rapidly or at a high speed to the bottom chamber 16B of the injection cylinder 16 and the injection cylinder 16 forces the molten metal in the injection sleeve 14 into the cavity 13 rapidly. In this case, no hydraulic oil in the bottom chamber 23B of the pressure boost cylinder 23 is supplied to the bottom chamber 16B of the injection cylinder 16. The hydraulic oil in the rod chamber 16R of the injection cylinder 16 is discharged to the reservoir 40.

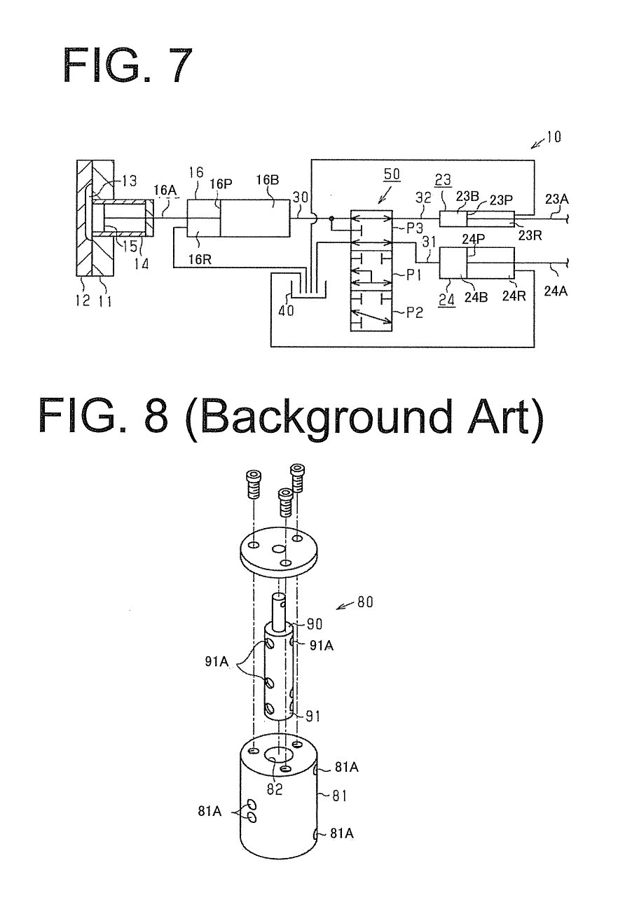

Referring to FIG. 7, when the rotary valve device 50 is placed in the third position P3, the bottom chamber 24B of the high-speed cylinder 24 is bought into communication with the reservoir 40 and the bottom chamber 23B of the pressure boost cylinder 23 is brought into communication with the bottom chamber 16B of the injection cylinder 16, respectively. In this third position P3 of the rotary valve device 50, the pressure boost phase operation is performed. That is, the hydraulic oil in the bottom chamber 23B of the pressure boost cylinder 23 is supplied to the bottom chamber 16B of the injection cylinder 16, so that the molten metal in the injection sleeve 14 is pressurized by the injection cylinder 16. Simultaneously, the hydraulic oil in the bottom chamber 24B of the high-speed cylinder 24 and in the rod chamber 16R of the injection cylinder 16 is discharged to the reservoir 40.

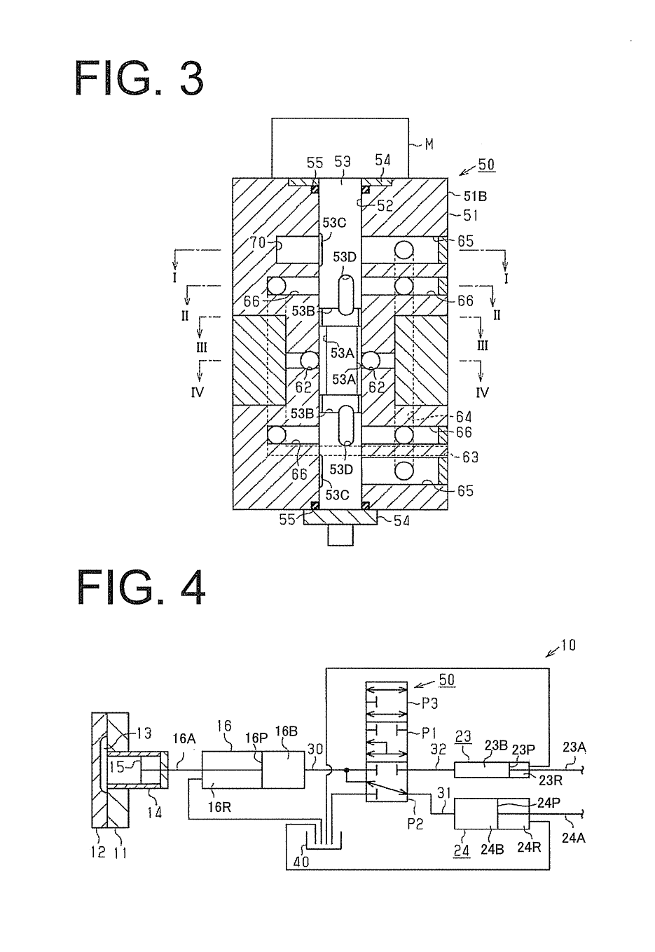

The followings will describe the configuration of the rotary valve device 50. Referring to FIG. 3, the rotary valve device 50 includes a valve body 51 of a rectangular box shape and a valve hole 52 formed in the valve body extending in longitudinal direction of the valve body 51, or vertically as seen in FIG. 3. For the sake of the description of the rotary valve device 50, the direction in which the axis of the valve hole 52 extends will be referred to as axial direction. The rotary valve device 50 has a cylindrical rotary valve 53 that is inserted in the valve hole 52 and rotatably supported by a bearing (not shown) mounted to the valve body 51.

The opposite ends of the valve hole 52 in the axial direction are closed by covers 54. The rotary valve device 50 is provided with a motor M that is mounted at one axial end of the valve hole 52 and drives to rotate the rotary valve 53. The rotary valve device 50 has low-pressure sealing members 55 on opposite ends of the valve hole 52, as a pair of sealing member. Specifically, the low-pressure sealing members 55 are provided in the valve hole 52 at the opposite ends thereof for sealing between the outer peripheral surface of the rotary valve 53 and the inner peripheral surface of the valve hole 52 thereby to prevent the leakage of hydraulic oil. In other words, the pair of low-pressure sealing members 55 are interposed between the inner peripheral surface of the valve hole 52 and the outer peripheral surface of the rotary valve 53 at respective opposite ends of the valve hole 52 in the axial direction thereof.

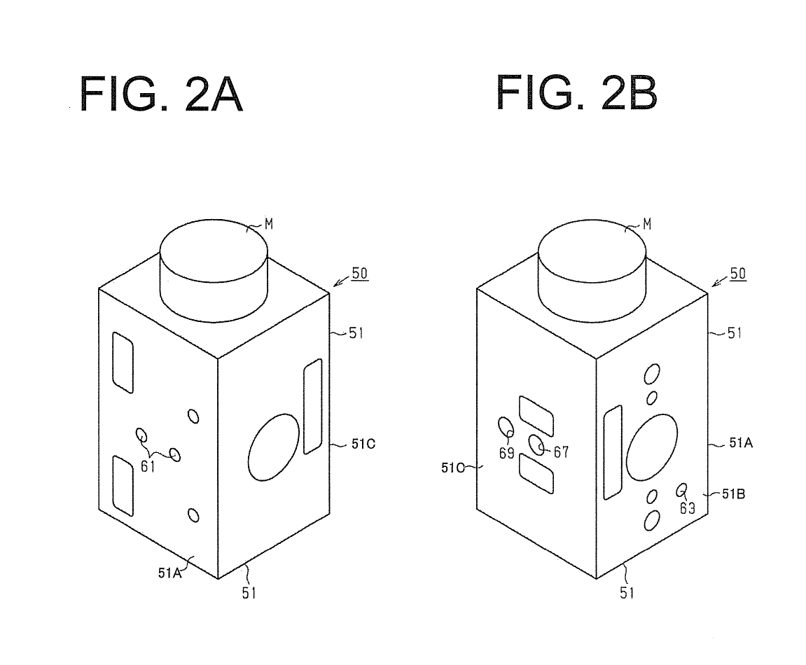

As shown in FIG. 2A, two first supply ports 61 are formed through a first side surface 51A of the valve body 51 in the axial center thereof. The second sub-tube 32, which is connected to the bottom chamber 23B of the pressure boost cylinder 23, is branched and connected to the first supply ports 61, respectively.

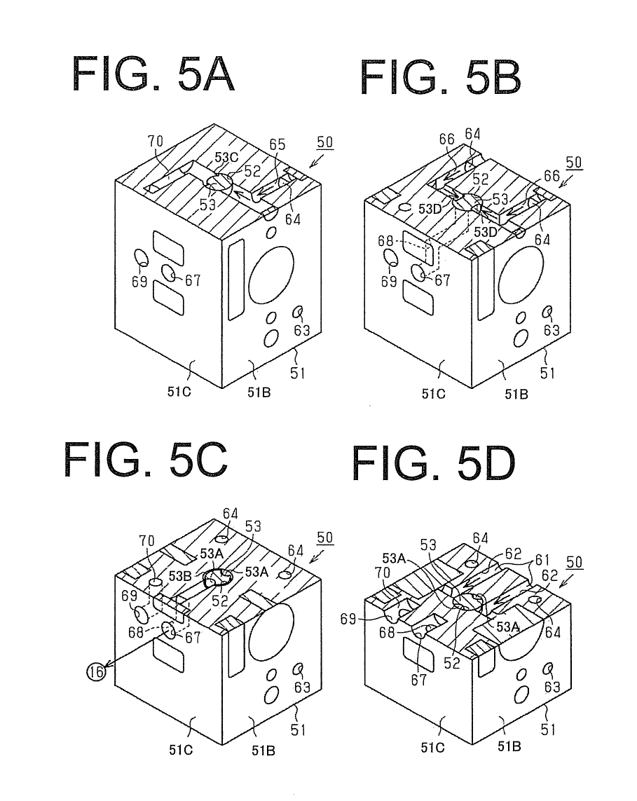

As shown in FIG. 5D, the valve body 51 of the rotary valve device 50 has therein a pair of first supply passages 62, one ends of which correspond to first supply port 61, respectively, and the other ends of which are connected to the valve hole 52 at positions on radially opposite sides of the valve hole 52. High-pressured hydraulic oil from the pressure boost cylinder 23 is flowed through the first supply port 61 and the first supply passages 62, and then supplied to the valve hole 52.

As shown in FIG. 2B, the valve body 51 has a second supply port 63 formed through a second side surface 51 B of the valve body 51, which is one of four surfaces extending perpendicularly to the first side surface 51A. The second supply port 63 is connected to the first sub-tube 31 that is connected to the bottom chamber 24B of the high-speed cylinder 24.

As shown in FIG. 3, the valve body 51 has therein a second supply passage 64 that extends parallel to the valve hole 52, and the second supply port 63 is connected to one end of the second supply passage 64. The opposite ends of the second supply passage 64 are branched into a first branched passage 65 and a second branched passage 66, respectively, through which opposite ends of the second supply passage 64 are connected to the valve hole 52. In other words, the valve body 51 has two branched passages 65, 66 that are branched from the second supply passage 64 on respective both end sides in the axial direction of the valve hole 52.

As shown in FIG. 5A, the first branched passages 65, which are positioned axially outward of the second branched passage 66 in the valve body 51, are connected to the valve hole 52. As shown in FIG. 5B, the second branched passages 66 are connected to the valve hole 52 at two positions on the radially opposite sides of the valve hole 52. Low-pressure hydraulic oil from the high-speed cylinder 24 is flowed through the second supply port 63 and the second supply passage 64, and then, supplied to the first branched passages 65 and the second branched passages 66.

As shown in FIG. 2B, the valve body 51 has an outlet port 67 formed through a third side surface 51C that is located on the side of the valve body 51 that is opposite from the first side surface 51A of the valve body 51. As shown in FIG. 5C, the outlet port 67 is connected to one end of an outlet passage 68, and the other end of which is connected to the valve hole 52. In addition, the outlet port 67 is connected to the other end of the main-tube 30, so that the outlet port 67 is connected to the bottom chamber 16B of the injection cylinder 16 through the main-tube 30.

As shown in FIG. 2B, a discharge port 69 is formed side by side with the outlet port 67 in the third side surface 51C of the valve body 51. As shown in FIGS. 3, 5C and 5D, the discharge port 69 is connected to one end of a discharge passage 70 that extends in the valve body 51 in the axial direction thereof, and the other end of the discharge passage 70 is connected to the valve hole 52 on the side thereof that is opposite the position at which the first branched passage 65 is connected to the valve hole 52. The discharge port 69 is also connected to the reservoir 40.

In the valve body 51, the sealing between the outer peripheral surface of the rotary valve 53 and the inner peripheral surface of the valve hole 52 may be accomplished by appropriately setting the clearance therebetween.

As shown in FIGS. 3 and 5C, the rotary valve 53 has around the outer periphery thereof and in the axial center thereof a pair of high-pressure communication passages 53A as the communication passage of the present invention and a pair of supply communication passages 53B connecting the ends of the respective high-pressure communication passage 53A. The high-pressure communication passages 53A are arranged on radially opposite sides of the rotary valve 53 and extend in the axial direction of the rotary valve 53, and the supply communication passages 53B extends in the radial direction of the rotary valve 53 and provides a fluid communication between the high-pressure communication passages 53A.

When the rotary valve device 50 is switched to the second position P2 with the rotation of the rotary valve 53, the paired high-pressure communication passages 53A are placed in a position where the communication between the first supply passages 62 and the outlet passage 68 is shut off, as shown in FIGS. 5C and 5C, so that the first supply port 61 and the outlet port 67 are not in communication with each other.

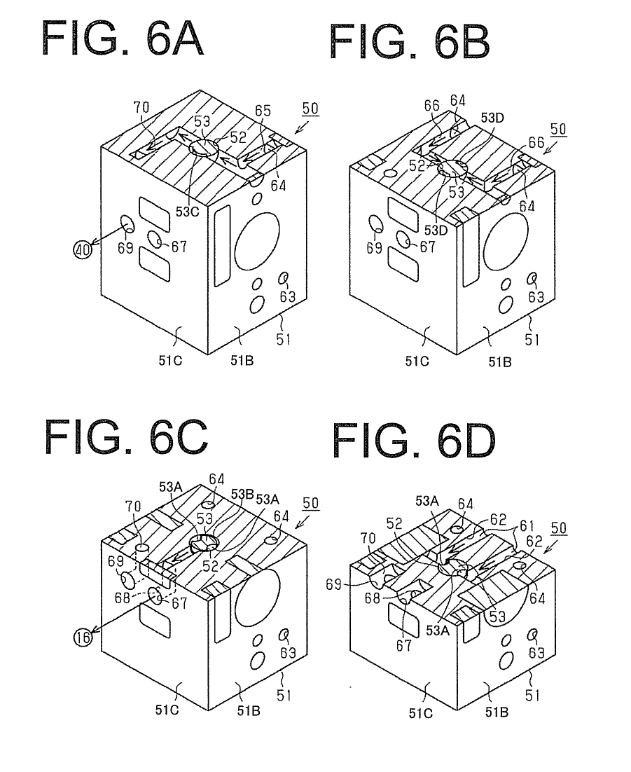

When the rotary valve device 50 is switched to the third position P3 with the rotation of the rotary valve 53, the paired high-pressure communication passages 53A are placed in the position that provides fluid communication between the first supply passages 62 and the outlet passage 68 via the high-pressure communication passage 53A, as shown in FIGS. 6C and 6D. Accordingly, the first supply port 61 communicates with the outlet port 67 via the first supply passages 62 and the outlet passage 68.

As shown in FIGS. 3 and 5A, the rotary valve 53 has in the outer periphery thereof and at positions adjacent to the opposite ends thereof a pair of discharge communication passages 53C as the communication passage of the present invention. Specifically, part of the rotary valve 53 is recessed in radial direction thereby to form the discharge communication passage 53C. In the second position P2 of the 50, the communication between the first branched passage 65 and the discharge passage 70 is shut-off, as shown in FIG. 5A, so that the second supply port 63 and the discharge port 69 are not in communication.

In the third position P3 of the rotary valve device 50, the discharge communication passage 53C provides a fluid communication between the first branched passage 65 and the discharge passage 70, as shown in FIG. 6A. thus providing a fluid communication between the second supply port 63 and discharge port 69.

As shown in FIGS. 3 and 6B, two pairs of low-pressure communication passages 53D are formed between the outer periphery of the rotary valve 53 and the inner periphery of the valve body 51 at positions that are axially inward of the discharge communication passages 53C. As shown in FIG. 6B, the low-pressure communication passages 53D of each pair are formed by recesses on opposite side of the rotary valve 53. The low-pressure communication passage 53D is communicable at one end thereof with the second branched passage 66 and is in communication at the other end thereof with the supply communication passage 53B. The low-pressure communication passage 53D extends in axial direction of the rotary valve 53.

In the second position P2 of the rotary valve device 50, the low-pressure communication passage 53D provides fluid communications between the second branched passage 66 and the outlet passage 68 and between the second supply port 63 and the outlet port 67 via the supply communication passage 53B, respectively, as shown in FIG. 5B. In the third position P3 of the rotary valve device 50 of FIG. 6B, the communication between the second branched passage 66 the outlet passage 68 is shut off, thus shutting off the communication between the second supply port 63 and the outlet port 67. In other words, flow of fluid hydraulic oil is regulated by the rotation of the rotary valve 53.

The following will describes the operation of the rotary valve device 50 of the present embodiment, beginning with the high-pressure phase operation.

As shown in FIG. 1, the piston 16P of the injection cylinder 16, the piston 24P of the high-speed cylinder 24 and the piston 23P of the pressure boost cylinder 23 are in their respective initial positions before the high-speed phase operation.

In such positions of the pistons 16P, 24P and 23P, no injection pressure is applied to the molten metal material in the injection sleeve 14 and the rotary valve device 50 is in the first position P1.

When the fixed mold member 11 and the movable mold member 12 have been clamped and the molten metal material has been fed into the injection sleeve 14, the high-speed phase operation starts and the rotary valve device 50 is switched to the second position P2.

As shown in FIG. 4, driving force from the power source causes the piston 24P of the high-speed cylinder 24 to make a forward movement, which causes hydraulic oil in the bottom chamber 24B of the high-speed cylinder 24 to flow through the first sub-tube 31 and the rotary valve device 50 into the bottom chamber 16B of the injection cylinder 16.

Specifically, the forward movement of the piston 24P of the high-speed cylinder 24 causes the hydraulic oil in the bottom chamber 24B to flow to the second supply port 63 of the rotary valve device 50 via the first sub-tube 31. The hydraulic oil is further flowed through the second supply passage 64, the second branched passage 66, and the low-pressure communication passage 53D and the supply communication passage 53B in the rotary valve 53 to the outlet passage 68. The hydraulic oil in the high-speed cylinder 24 is thus supplied to the bottom chamber 16B of the injection cylinder 16 from the outlet passage 68 via the outlet port 67.

Simultaneously, the hydraulic oil supplied to the second supply port 63 is flowed through the second supply passage 64 and the first branched passage 65. Because the discharge communication passage 53C of the rotary valve 53 then provides no fluid communication between the first branched passage 65 and the discharge passage 70, however, the hydraulic oil supplied from the high-speed cylinder 24 is not discharged to the reservoir 40.

Furthermore, in the second position P2 of the rotary valve device 50 shown in FIG. 5D, the high-pressure communication passage 53A of the rotary valve 53 is not in communication with the first supply passage 62, thus shutting off the communication between the first supply passage 62 and the outlet passage 68. Accordingly, no hydraulic oil is supplied from the pressure boost cylinder 23.

From the start of the high-speed phase operation, the injection pressure is gradually increased to a predetermined level. During the high-speed phase operation, the injection cylinder 16 causes the injection plunger 15 to inject a molten metal material at a high-speed, and resistance is generated against the forward movement of the piston 16P after the cavity 13 of the mold members 11, 12 has been filled with the molten metal. Thus, the injection pressure in the bottom chamber 16B of the injection cylinder 16 is increased by the hydraulic oil from the high-speed cylinder 24 and, when the piston 16P of the injection cylinder 16 is moved to a predetermined position, the rotary valve device 50 is switched to the pressure boost phase operation.

In the pressure boost phase operation, the rotary valve device 50 is placed in the third position P3. Referring to FIG. 7 showing the rotary valve device during the pressure boost phase operation, the piston 23P of the pressure boost cylinder 23 is driven by the power source to make a forward movement, which causes the hydraulic oil in the bottom chamber 23B of the pressure boost cylinder 23 to flow through the second sub-tube 32 and the rotary valve device 50 into the bottom chamber 16B of the injection cylinder 16.

The forward movement of the piston 23P of the pressure boost cylinder 23 causes the hydraulic oil in the bottom chamber 23B to flow to the first supply port 61 of the rotary valve device 50 via the second sub-tube 32. Consequently, the hydraulic oil in the first supply port 61 is flowed through the first supply passage 62 and the outlet passage 68 via the high-pressure communication passage 53A and then supplied to the supply communication passage 53B, as shown in FIG. 6D. Thus, the hydraulic oil in the pressure boost cylinder 23 is supplied to the bottom chamber 16B of the injection cylinder 16 via the outlet port 67.

Simultaneously, the hydraulic oil supplied to the second supply port 63 is flowed through the second supply passage 64 and the first branched passage 65 and to the discharge passage 70 via the discharge communication passage 53C of the rotary valve 53. Accordingly, the hydraulic oil in the second supply port 63 is discharged from the discharge passage 70 to the reservoir 40 via the discharge port 69.

At this time, the fluid communication between the second branched passage 66 and the outlet passage 68 is shut off, so that the hydraulic oil in the second branched passage 66 is not allowed to be discharged from the outlet port 67.

The hydraulic oil supplied from the pressure boost cylinder 23 to the bottom chamber 16B of the injection cylinder 16 increases the pressure in the bottom chamber 16B of the injection cylinder 16 and, consequently, the pressure in the bottom chamber 16B that is applied to the piston 16P of the injection cylinder 16 is also increased. Accordingly, the injection pressure to pressurize the molten metal material in the cavity 13 is increased.

When the metal material in the cavity 13 has been solidified, the fixed mold member 11 and the movable mold member 12 are opened and a molded article is removed. The above described embodiment offers the following effects.

(1) In the rotary valve device 50 wherein the first supply passage 62 that supplies high-pressure hydraulic oil is formed around the axial center of the valve hole 52 while the second supply passage 64 that supplies fluid having lower pressure than that of the hydraulic oil supplied by the first supply passage is formed at positions closer to the ends of the valve hole 52 in the axial direction thereof than the first supply passage 62, the low-pressure sealing member 55 may be used effectively to prevent low-pressure hydraulic oil from leaking from the opposite ends of the valve hole 52. If high-pressure hydraulic oil is flowed in the axial opposite ends of the valve hole 52, a high-pressure sealing member needs to be used, which causes greater resistance acting on the rotary valve 53. The use of the low-pressure sealing member 55 helps to reduce the sliding resistance of the rotary valve 53, thus allowing the rotary valve 53 to rotate at an increased speed.
(2) In the valve body 51, non-contact sealing is accomplished between the ports by appropriately setting the clearance therebetween. The sliding resistance of the rotary valve 53 is only due to the low-pressure sealing member 55, so that the rotation of the rotary valve 53 may be increased.
(3) In the configuration in which the first supply passages 62 through which high-pressure hydraulic oil is flowed are connected to the valve hole 52 at positions that are on radially opposite positions of the valve hole 52, the hydraulic oil having substantially the same pressure acts on the rotary valve 53 from radially opposite position thereof, so that the rotary valve 53 is supported in the hydraulic oil in a floated manner. Such configuration of the rotary valve device 50 prevents the rotary valve 53 from tilting in the valve hole 52 and hence prevents any part of the rotary valve 53 from contacting the inner peripheral surface of the valve hole 52. Therefore, the sliding resistance during the rotation of the rotary valve 53 is caused only by the low-pressure sealing member 55. This enables the rotary valve 53 to increase its rotation speed.
(4) The first branched passage 65 and the second branched passage 66 of the second supply passage 64 are formed on one side of the valve body 51 with respect to the valve hole 52. Thus, the second supply passage 64 including the first branched passage 65 and the second branched passage 66 may be formed easily. The first branched passage 65 communicates with the valve hole 52 only on one side thereof, which may cause the rotary valve 53 to be tilted. Because the hydraulic oil supplied through the first branched passage 65 is low-pressure oil, however, such tilting may be prevented.
(5) After the high-speed phase operation is performed by the high-speed cylinder 24 in the second position P2 of the rotary valve device 50, the pressure boost phase operation is performed by the pressure boost cylinder 23 in the second position P3 of the rotary valve device 50 with the high-speed cylinder 24 in communication with the reservoir 40. Compared with the case in which two valves are used to change the connection to the injection cylinder 16, that is, after a first valve is used for the high-speed phase operation, a second valve is used to connect the high-speed cylinder 24 to the reservoir 40 and then the first valve is used again for the pressure boost phase operation, the rotary valve device 50 according to the present embodiment need not change valves depending on the operation. Thus, the time for shifting the high-speed phase operation to the pressure boost phase operation may be reduced.

Therefore, the molten metal material filling the cavity 13 in the high-speed phase is hardly cooled by the fixed mold member 11 and the movable mold member 12, so that the molten metal material is adequately forced into the cavity 13 during the pressure boost phase. The resulting molded article has a high density and an increased strength, thus accomplishing high quality.

The above-described embodiment may be modified in various manners, as exemplified below.

The rotary valve device 50 is applicable to a device other than the injection molding device 10.

Although the rotary valve device 50 is used in the injection molding device 10 for changing the flow passage in the high-speed phase operation and the pressure boost phase operation, the rotary valve device 50 may be used in an injection molding device having a low-speed cylinder and a high-speed cylinder for changing the flow passages.

The first supply passages 62 through which high-pressure hydraulic oil is flowed may not be formed on radially opposite positions of the valve hole 52.

The first and second branched passages 65, 66 of the second supply passage 64 may not be formed only on one side of the valve hole 52 in the valve body 51.

Although the opposite axial ends of the second supply passage 64 are in communication with the valve hole 52 according to the present embodiment, the second supply passage 64 may be in communication with one end of the valve hole 52.

The numbers of the ports and the communication passages in the rotary valve device 50 may be changed as required.

What is claimed is:

1. A rotary valve device comprising:
a valve body having a valve hole and a plurality of ports connected to the valve hole;
a rotary valve rotatably supported in the valve hole and having a plurality of communication passages; and
a motor driving to rotate the rotary valve to regulate flow of a fluid,
wherein the valve body has a first supply passage that interconnects the valve hole and at least one of the ports, and a second supply passage that interconnects the valve hole and at least another of the ports, wherein the second supply passage is connected to the valve hole at a position that is closer to an end of the valve hole in an axial direction of the valve hole than the first supply passage, wherein the fluid supplied from the second supply passage to the valve hole when the second supply passage communicates with the valve hole has lower pressure than the fluid supplied from the first supply passage to the valve hole when the first supply passage communicates with the valve hole, and wherein a pair of sealing members are interposed between an inner peripheral surface of the valve hole and an outer peripheral surface of the rotary valve at respective opposite ends of the valve hole in the axial direction of the valve hole.

2. The rotary valve device according to claim 1, wherein when the fluid is supplied from the first supply passage to the valve hole, the fluid flows through radially opposite positions of the valve hole.

3. The rotary valve device according to claim 1, wherein an injection molding device includes an injection plunger that injects and fills a molding material into a cavity and pressurizes the molding material, an injection cylinder that causes the injection plunger to inject the molding material, a high-speed cylinder that supplies hydraulic oil as the fluid to the injection cylinder to cause the injection plunger to inject the molding material at a high-speed, a pressure boost cylinder that supplies the hydraulic oil to the injection cylinder to cause the injection plunger to pressurize the molding material, and a switch valve that changes connection to the injection cylinder of the pressure boost cylinder and connection to the injection cylinder of the high-speed cylinder, wherein the rotary valve device is adapted for use in the injection molding device as the switch valve, and wherein the first supply passage is connected to the pressure boost cylinder and the second supply passage is connected to the high-speed cylinder.

4. The rotary valve device according to claim 1, wherein the valve body has two branched passages that are branched from the second supply passage on respective both end sides in the axial direction of the valve hole.
